(19) United States
(12) Patent Application Publication
(10) Pub. No.: US 2022/0178041 A1
(43) Pub. Date: Jun. 9, 2022

(54) Reflow Melting System and Terminal Production System

(71) Applicants: Tyco Electronics (Shanghai) Co. Ltd., Shanghai (CN); Tyco Electronics (Suzhou) Ltd., Suzhou City (CN)

(72) Inventors: Daiqiong (Diana) Zhang, Shanghai (CN); Chunyan (Cherie) Zhou, Shanghai (CN); Dongqing (Gates) Peng, Suzhou (CN); Jialin Zhang, Shanghai (CN); Zhongxi Huang, Shanghai (CN)

(73) Assignees: Tyco Electronics (Shanghai) Co. Ltd., Shanghai (CN); Tyco Electronics (Suzhou) Ltd., Suzhou City (CN)

(21) Appl. No.: 17/541,733

(22) Filed: Dec. 3, 2021

(30) Foreign Application Priority Data
Dec. 3, 2020 (CN) 202011394419.1

(51) Int. Cl. C25D 5/50; B23K 26/06; B21B 41/08; B23K 26/03; B23K 26/16; C25D 7/00; H01R 43/16; B23K 26/142; B23K 26/342; B25J 19/02; B23K 26/70; B23K 26/08

(52) U.S. Cl. CPC C25D 5/505; B23K 26/0619; B21B 41/08; B23K 26/032; B23K 26/16; C25D 7/00; B23K 26/0884; B23K 26/142; B23K 26/0626; B23K 26/342; B25J 19/023; B23K 26/703; H01R 43/16

(57) ABSTRACT

A reflow melting system for reflow melting a metal coating on an electrical contact area of a terminal includes a laser head for emitting a laser light onto the metal coating on the terminal to heat and melt the metal coating. A remote control terminal is provided in communication with the laser head for adjusting at least one working parameter of the laser head for optimizing the melting effect of the metal coating.

### CROSS-REFERENCE TO RELATED APPLICATIONS

This application claims the priority benefit of Chinese Patent Application No. CN202011394419.1 filed on Dec. 3, 2020 in the State Intellectual Property Office of China, the whole disclosure of which is incorporated herein by reference.

### FIELD OF THE INVENTION

The present disclosure relates to a reflow melting system, and to a terminal production system including the reflow melting system.

### BACKGROUND

Tin plating, indium plating, bismuth plating, lead plating and other low melting point metal coatings are not as conductive as gold plating, platinum and other precious metals, but they are also in the forefront of most metals, especially tin plating. Because of its low melting point, good ductility and low price, tin plating is widely used in electrical connectors and their mutual terminals. With the rapid development of terminal crimping technology, and the increasing mobile applications such as vehicles, the requirements for the hardness and durability of electrical connectors are correspondingly strict. However, in order to maintain enough crimping retention force (pull-out force) to prevent loose connections caused by vibration and keep enough low contact resistance, the required insertion force increases greatly. One of the problems is the difficulty of assembly and insertion, and excessive damage to the tin coating at both ends during mating. A second problem is that the insertion damage will aggravate the growth of tin whiskers in the tin coating, and cause adjacent terminals or printed circuit board (PCB) lines to short circuit.

In order to solve the above problems, reflow tin processing is applied. Using reflow processing, the tin layer is cooled and recrystallized after melting, and the free molten tin forms intermetallic compound with the base layer or the intermediate coating. As a result, the hardness increases, the wear resistance decreases, the surface roughness decreases, the friction coefficient decreases, and the insertion force decreases under the same pressure. At the same time, the internal stress of the tin layer is released after remelting, which further reduces the risk of tin whisker. At present, electric furnace/infrared baking and inductor melting are commonly used in reflow tin melting.

Regarding reflow baking, including common SMT reflow baking or welding, melting heat is generated by an electric heating wire or infrared lamp tube. The thermal action mode is thermal radiation baking, which has low efficiency, high energy consumption, difficult quality stability control and requires very large equipment. Moreover, these processes lack the ability to selectively heat in localized areas.

At present, the inductive melting method is also used in a small number of planar terminals with simple structures. Its heat source is an alternating electromagnetic field, and the thermal action mode includes the rapid heating of the tinned work piece due to the superficial eddy current circuit generated in the magnetic field. While the method has high heating efficiency, the amount of heat generated can only roughly be controlled via frequency and power adjustments. Further, heat generation is greatly affected by the position of the work piece and the induction coil, and the stability of tin melting is very poor.

Accordingly, improved reflow melting systems are desired.

### SUMMARY

According to an embodiment of the present disclosure a reflow melting system for reflow melting a metal coating on an electrical contact area of a terminal includes a laser head for emitting a laser light onto the metal coating on the terminal to heat and melt the metal coating. A remote control terminal is provided in communication with the laser head for adjusting at least one working parameter of the laser head for optimizing the melting effect of the metal coating.

### BRIEF DESCRIPTION OF THE DRAWINGS

The invention will now be described by way of example with reference to the accompanying Figures, of which:

FIG. 1 shows a schematic diagram of a terminal production system according to an exemplary embodiment of the present invention;

FIG. 2 shows a schematic diagram of a terminal strip according to an exemplary embodiment of the present invention;

FIG. 3 shows a schematic diagram of a terminal strip according to another exemplary embodiment of the present invention;

FIG. 4a shows an electron micrograph of a metal coating without reflow melting;

FIG. 4b shows an electron micrograph of a metal coating melted by baking reflow; and

FIG. 4c shows an electron micrograph of a metal coating which has been melted by laser reflow according to the present invention.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure a reflow melting system for reflow melting a metal coating on an electrical contact area of a terminal includes a laser head configured to emit laser light to the metal coating on the terminal to heat and melt the metal coating. A terminal production system according to another embodiment includes a terminal strip on which a plurality of terminals arranged along the length direction of the terminal strip are formed. An electroplating device is provided and adapted to form a metal coating on an electric contact area of the terminal. A reflow melting system according to embodiments is used to reflow melt the metal coating formed on the electrical contact area of the terminal.

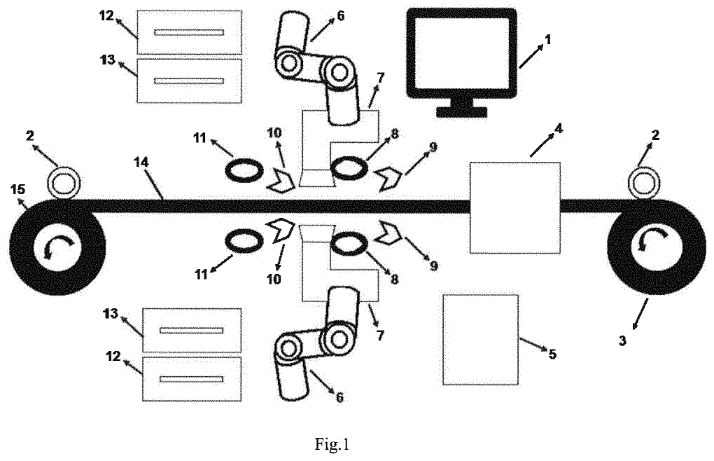

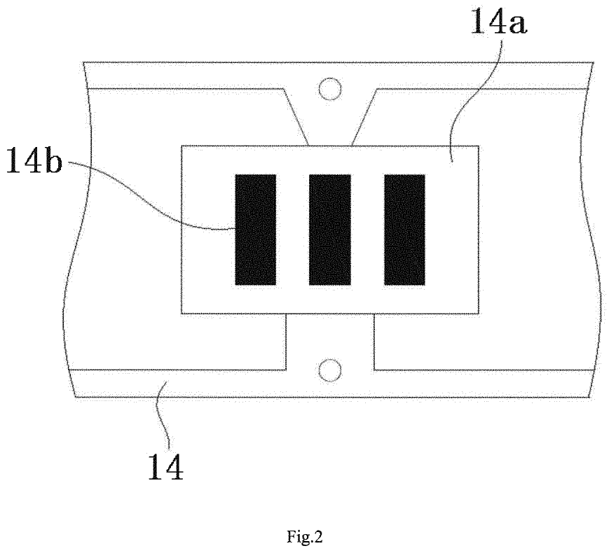

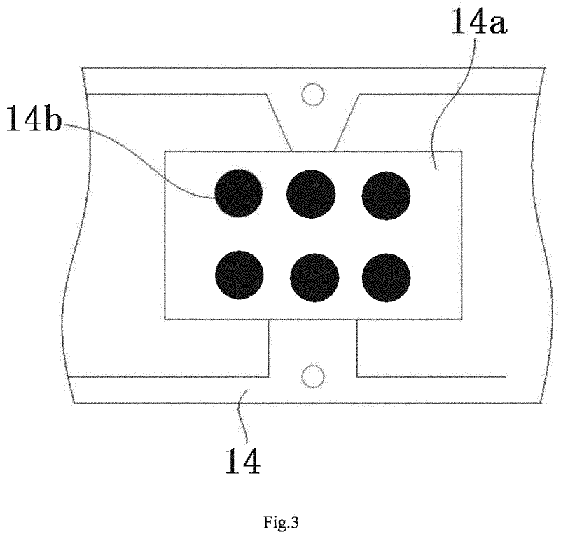

FIG. 1 shows a schematic diagram of a terminal production system according to an exemplary embodiment of the present invention. FIG. 2 shows a schematic diagram of a terminal strip 14 according to an exemplary embodiment of the present invention. FIG. 3 shows a schematic diagram of a terminal strip 14 according to another exemplary embodiment of the present invention.

As shown in FIGS. 1-3 in an embodiment, the terminal production system mainly comprises the terminal strip 14, an electroplating device 4 and a reflow melting system. A plurality of terminals 14a are formed on the terminal strip 14 and arranged along the length direction of the terminal strip 14. The electroplating device 4 is adapted to form a metal coating 14b on an electric contact area of the terminal 14a. The reflow melting system is adapted to reflow melt the metal coating 14b formed on the electrical contact area of the terminal 14a.

According to an embodiment, the terminal production system further comprises a feeding device 2, 3, 15. The feeding device 2, 3, 15 is adapted to convey the terminal strip 14 to successively pass through the electroplating device 4 and the reflow melting system. In this way, the system enables continuous electroplating and reflow melting of the terminal 14a. The feeding device 2, 3, 15 mainly comprises a feeding reel 3 and a recovery reel 15. The terminal strip 14 without the formed metal coating 14b is wound on the feeding reel 3. The terminal strip 14 with the metal coating 14b that has been melted and recrystallized is wound on the recovery reel 15. The recovery reel 15 is driven to rotate at a predetermined speed, so as to pull the terminal strip 14 to move from the feeding reel 3 to the recovery reel 15. In an embodiment, the feeding device 2, 3, 15 further comprises two pressing rollers 2. The two pressing rollers 2 are respectively located at the feeding reel 3 and the recovery reel 15. The two pressing rollers 2 are adapted to press the terminal strip 14 on the feeding reel 3 and the recovery reel 15, respectively.

As shown in FIG. 1, in an embodiment, the metal coating 14b is respectively formed on the front and back surfaces of the terminal 14a. The reflow melting system is adapted to reflow melting the metal coatings 14b on the front and back surfaces of the terminal 14a at the same time. In this way, the production efficiency can be improved.

Hereafter, the reflow melting system according to an exemplary embodiment of the present invention will be described in detail below with reference to the figures. Still referring to FIGS. 1-3, the reflow melting system is primarily used for reflow melting the metal coating 14b on an electrical contact area of the terminal 14a. According to embodiments, two such systems are provided on each side of the terminal 14, as illustrated in FIG. 1. Each reflow melting system includes at least one laser head 7. The laser head 7 is configured to emit laser light to the metal coating 14b on the terminal 14a to heat and melt the metal coating 14b. The molten metal coating 14b will recrystallize after cooling, which will greatly improve its performance. In general, the laser head 7 includes a laser source, a beam expander, a field mirror, and a galvanometer. Suitable commercially-available lasers and their supporting equipment may be utilized, and therefore, further description of the structure and composition of the laser head 7 will not be provided.

Referring particularly to FIG. 1, the reflow melting system may further comprise a manipulator 6. The laser head 7 is mounted on the manipulator 6. The manipulator 6 is configured to move the laser head 7 to scan and heat each metal coating 14b on the terminal 14a.

A laser controller 12 is provided for communicating with the laser head 7 for controlling its operation. A laser power box 13 is electrically connected with the laser head 7 for supplying power to the laser head 7. In one embodiment, the laser controller 12, the laser power box 13 and the laser head 7 are integrated and installed on the manipulator 6 together.

The reflow melting system may further comprise a remote control terminal 1. The remote control terminal 1 communicates with the manipulator 6 and the laser controller 12 for setting the working parameters of the laser head 7 and the operating parameters and programs of the manipulator 6. The remote control terminal 1 can set laser parameters (e.g., power, frequency, defocus, scanning speed, scanning pattern, etc.) and the manipulator operation programs (e.g., select different melting areas, switch different melting surfaces, etc.). The terminal 1 is further adapted to output high-definition pictures of melting objects on-line for monitoring and tracing quality records, and can automatically correct the operation of laser 7 and manipulator 6. The terminal 1 may include one or more processors and associated memory devices storing and executing programming for performing the functions described herein.

The reflow melting system may further comprise a first image sensor 8 (e.g., a microscope or camera). The first image sensor 8 is mounted on the manipulator 6 or the laser head 7 to move synchronously with the laser head 7. The first image sensor 8 is configured to capture an image of the metal coating 14b which is being heated and melted by laser light in real time. The remote control terminal 1 adjusts the working parameters of the laser head 7 and the operating parameters of the manipulator 6 in real time according to the image captured by the first image sensor 8, so as to optimize the working parameters of the laser head 7 and the operating parameters of the manipulator 6 and improve the melting effect of the metal coating 14b.

The reflow melting system may further comprise a second image sensor 11 (e.g., a microscope or camera). The second image sensor 11 is configured to capture the image of the metal coating 14b which has been melted by laser light. The remote control terminal 1 adjusts the working parameters of the laser head 7 and the operating parameters of the manipulator 6 in real time according to the image captured by the second image sensor 11, so as to optimize the working parameters of the laser head 7 and the operating parameters of the manipulator 6 and improve the melting effect of the metal coating 14b.

The reflow melting system may further comprise a negative pressure dust washing device 9 (e.g., a vacuum). The negative pressure dust washing device 9 is configured to remove a small amount of vaporized coating metal by suction, so as to prevent the vaporized coating metal from cooling and condensing on the surface of the molten metal coating again. A blowing protection device 10 may also be implemented and is adapted to spray a compressed gas to the metal coating to remove dust on the metal coating. The compressed gas may comprise compressed air or compressed inert gas. The compressed inert gas may be, for example, compressed argon or nitrogen.

The reflow melting system may further comprise a laser cooling device 5. The laser cooling device 5 is configured to cool a laser pump in the laser head 7, so as to ensure the long-term stable operation of a laser in the laser head 7. The laser cooling device 5 may comprise a water cooling device, an air cooling device or a water air mixed cooling device.

Referring again to FIGS. 1-3, in an embodiment, the metal coating 14b on the terminal 14a is a tin coating. However, the present invention is not limited to this, and the metal coating 14b on the terminal 14a can also be indium coating, bismuth coating, lead coating or any other suitable metal coating. The shape of the metal coating 14b on the terminal 14a may be round, rectangular, oval or any other suitable shape.

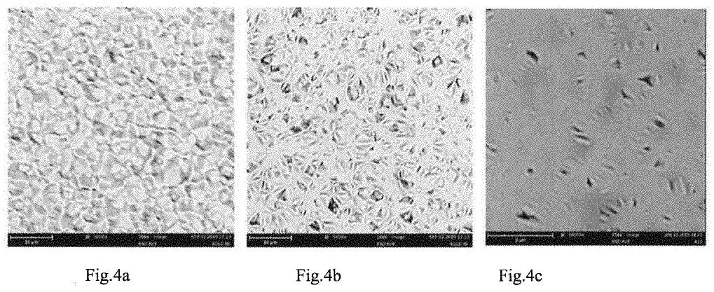

FIG. 4a shows an electron micrograph of a metal coating without reflow melting. FIG. 4b shows an electron micrograph of a metal coating melted by baking reflow. And FIG. 4c shows an electron micrograph of a metal coating which has been melted by laser reflow according to the present invention.

As shown in FIGS. 4a, 4b and 4c, the quality of the metal coating after laser reflow melting is stable and reliable, and of higher quality than that of metal coating after the above-described baking reflow melting.

The system according to embodiments utilizes the pulse width and vibration frequency of the infrared laser in a certain range to convert the heat energy far greater than the atomic energy, adjusts the laser power and scanning speed, and precisely controls the energy of each point (20-50 microns in diameter) to make the tin melt and recrystallize. As each laser head is equipped with a manipulator, the laser can act on different areas of the work piece (terminal) independently or simultaneously. The work piece can be stationary or moving. The laser further includes a flight or path tracking function. The laser system is equipped with dust extraction and blowing function, which is used to remove a small amount of tin gasified by atomic energy. The blowing gas can be compressed air or inert gas, which is used to reduce tin oxidation. The laser head is equipped with a coaxial CCD microscope (the first image sensor 8) or a CCD microscope (the second image sensor 11) for on-line detection. The detection results can be interconnected with the laser software to automatically correct the laser parameters and molten tin size on-line synchronously. The laser reflow melting system can be used independently or embedded in the high-speed tin plating process.

The tin melting heat source of the present disclosure is laser, the thermal action mode is that the tin layer absorbs photon energy, pulse high-speed scanning, gradually accumulating the tin melting area at high speed, and the tin melting area or pattern can be preset according to the functional area, so it has high selectivity, and the tin melting size precision can be controlled within 50 microns. Because of the density of energy points and the uniformity of energy in each point, the quality of molten tin is very stable and reliable (as shown in FIGS. 4a, 4b and 4c, full melting and recrystallization, compared with baking method, the original crystalline state cannot be seen under high power electron microscope). The speed of a single laser can reach 3-10 square millimeter per second, which can fully match the current tin plating speed. Because the tin melting is completed in an instant and there is no time to oxidize and cool immediately in the air, the tin surface oxide layer is extremely thin and the contact resistance is far lower than that of the baking methods. After melt recrystallization, the wear resistance increases and the friction coefficient decreases significantly, which is comparable to the industry standard SMT reflow method.

Further, embodiments of the present disclosure provide the following benefits:

Energy saving, safety: tin melting with laser, no high-power heating baking, no fire hazards;

High efficiency and intelligence: the invention can connect the work piece tin melting area design drawing, laser tin melting laser and machine arm through software to complete tin melting efficiently and intelligently;

Precision tin melting: the precision of the invention can be controlled within 50 um;

Stable quality: the laser instantly complete melting, uniform recrystallization, almost no oxidation, low contact resistance, enhanced wear resistance, low friction coefficient.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A reflow melting system for reflow melting a metal coating on an electrical contact area of a terminal, comprising:
a laser head for emitting laser light onto the metal coating on the terminal to heat and melt the metal coating; and
a remote control terminal in communication with the laser head for adjusting at least one working parameter of the laser head for optimizing the melting effect of the metal coating.

2. The reflow melting system according to claim 1, further comprising a manipulator on which the laser head is mounted for moving the laser head to scan and heat the metal coating on the terminal.

3. The reflow melting system according to claim 2, further comprising a laser controller communicated with the laser head for controlling the laser head.

4. The reflow melting system according to claim 3, further comprising a laser power box electrically connected with the laser head for supplying power to the laser head.

5. The reflow melting system according to claim 4, wherein the laser controller, the laser power box and the laser head are integrated and installed on the manipulator.

6. The reflow melting system according to claim 3, wherein the remote control terminal communicates with the manipulator and the laser controller for setting working parameters of the laser head and the operating parameters and programs of the manipulator.

7. The reflow melting system according to claim 6, further comprising a first image sensor mounted on the manipulator or the laser head to move synchronously with the laser head, the first image sensor is adapted to capture an image of the metal coating which is being heated and melted by laser light in real time, the remote control terminal adjusting the working parameters of the laser head and the operating parameters of the manipulator in real time according to the image captured by the first image sensor, so as to optimize the working parameters of the laser head and the operating parameters of the manipulator and improve the melting effect of the metal coating.

8. The reflow melting system according to claim 7, further comprising a second image sensor adapted to capture an image of the metal coating which has been melted by laser light, the remote control terminal adjusting the working parameters of the laser head and the operating parameters of the manipulator in real time according to the image captured by the second image sensor, so as to optimize the working parameters of the laser head and the operating parameters of the manipulator and improve the melting effect of the metal coating.

9. The reflow melting system according to claim 1, further comprising a negative pressure dust washing device for removing a vaporized coating metal by suction, so as to prevent the vaporized coating metal from cooling and condensing on the surface of the molten metal coating again.

10. The reflow melting system according to claim 9, further comprising a blowing protection device for spraying a compressed gas on the metal coating to remove dust on the metal coating.

11. The reflow melting system according to claim 10, wherein the compressed gas is compressed air or compressed inert gas.

12. The reflow melting system according to claim 1, further comprising a laser cooling device for cooling a laser pump in the laser head.

13. The reflow melting system according to claim 12, wherein the laser cooling device is a water cooling device, an air cooling device or a water air mixed cooling device.

14. The reflow melting system according to claim 1, wherein the laser head includes a first laser head emitting light on a first side of the terminal, and a second laser head emitting laser light on a second side of the terminal, opposite the first side, for melting metal coatings formed on the first and second sides of the terminal.

15. The reflow melting system according to claim 1, further comprising a feeding device for conveying a terminal strip including a plurality of the terminals, including:
a feeding reel on which the terminal strip without forming the metal coating is wound;
a recovery reel on which the terminal strip with the metal coating that has been melted and recrystallized is wound, the recovery reel rotates at a predetermined speed to pull the terminal strip to move from the feeding reel to the recovery reel; and
two pressing rollers respectively located at the feeding reel and the recovery reel for pressing the terminal strip on the feeding reel and the recovery reel.

16. A terminal production system, comprising:
a terminal strip on which a plurality of terminals arranged along the length direction of the terminal strip are formed;
an electroplating device configured to form a metal coating on an electric contact area of the terminal; and
a reflow melting system including a laser head adapted to emit laser light onto the metal coating to reflow melt the metal coating formed on the electrical contact area of the terminal.

17. The terminal production system according to claim 16, further comprising a feeding device for conveying the terminal strip to successively pass through the electroplating device and the reflow melting system.

18. The terminal production system according to claim 17, wherein the feeding device comprises:
a feeding reel on which the terminal strip without forming the metal coating is wound; and
a recovery reel on which the terminal strip with the metal coating that has been melted and recrystallized is wound, the recovery reel rotates at a predetermined speed to pull the terminal strip to move from the feeding reel to the recovery reel.

19. The terminal production system according to claim 18, wherein the feeding device further comprises two pressing rollers respectively located at the feeding reel and the recovery reel for pressing the terminal strip on the feeding reel and the recovery reel.

20. The terminal production system according to claim 16, wherein the metal coating is respectively formed on the front and back surfaces of the terminal, and the reflow melting system is adapted to reflow melt the metal coatings on the front and back surfaces of the terminal at the same time.
